(19) United States
(12) Patent Application Publication
(10) Pub. No.: US 2006/0245138 A1
(43) Pub. Date: Nov. 2, 2006

(54) Perforated plate for water chuck

(76) Inventors: Meng Fai Koh, Singapore (SG); Choon Siong Poh, Singapore (SG); Teck Leong, Singapore (SG); Theng Wei, Singapore (SG); Bing Wang, Singapore (SG)

Correspondence Address: Harness Dickey & pierce, 7700 Bonhomme, Suite 4000, St Louis, MO, 63105-1932, US

(21) Appl. No.: 10/537,840

(22) PCT Filed: Jul. 14, 2003
(86) PCT No.: PCT/SG03/00170

§ 371 Date: Jun. 7, 2005

(51) Int. Cl. H01T 23/00

(52) U.S. Cl. 361/234

(57) ABSTRACT

A perforated plate for use in a wafer-handling chuck has a pattern of through holes by which a vacuum is applied to a membrane to form suctions cups that secure a wafer to the chuck. Grooves in a generally planar upper surface of the plate interconnect the through holes. The grooves ensure the maintenance of the vacuum, and the consequent formation of the membrane suction cups, at each through hole, even when the grooved surface of the plate is in close face-to-face contact with another planar surface in the chuck. In one embodiment, the through holes in the perforated plate lie on concentric circles and the grooves interconnect radially-outward through holes to the next closest one or pair or radially-inward through holes.

### FIELD OF INVENTION

The present invention relates to improvements in perforated plates used in a wafer support or chuck system and particularly to such systems used to carry semiconductor wafers during fabrication, for example fabrication of integrated circuits and micro electro-mechanical devices, and more particularly during polishing or planarization of such wafers.

### BACKGROUND

As part of the fabrication of a semiconductor wafer, a face of the wafer may be planarized by a chemical/mechanical polishing (CMP). This planarization may be used to reduce the thickness of the wafer itself, or of a layer built up or deposited on a face of the wafer. Alternatively, the surface of a patterned wafer may be made flat to maintain the photo-lithographic depth of focus for subsequent patterning steps and/or to limit deformation of subsequently deposited layers, e.g. metallization layers.

The wafer is held in a chuck which presses the wafer against a rotating polishing pad in the presence of an abrasive slurry mixture. The surface of the wafer is abraded by the very fine abrasive particles while being slightly etched by the reactive slurry liquid. The mechanical abrasion preferentially removes the higher topographical features, which is not achieved by chemical etching alone.

U.S. Pat. No. 5,423,716 describes a wafer chuck with a wafer backing plate or piston, having a pattern of recessed regions on its lower face. A soft resilient membrane covers the underside of the backing plate. The chuck acquires a wafer by elevating the wafer so that its upper face contacts the lower side of the membrane. A vacuum is applied to the recessed regions which draws the membrane against the underside of the backing plate and into the recessed regions. Each region provides a suction cup that draws the wafer against the membrane. In a polishing process, the acquired wafer is positioned over a polishing pad. A positive pressure applied to the regions lifts the piston backing plate off the membrane and applies an even pressure across the membrane and thus across the wafer. On completion of the polishing process, a vacuum is applied to the recessed regions of the backing plate which lowers on to the membrane to repeat the wafer acquisition process. The chuck can then remove the wafer to the next station where the wafer can be released from the chuck by venting the recessed regions to atmosphere or by applying a positive pressure to the regions.

In another similar chuck, the backing plate has a pattern of through holes and the rise and fall of the plate is driven by an inflatable tube. To acquire a wafer, the chuck is positioned over the wafer and the plate is lowered by inflation of the tube to press the membrane against the upper face of the wafer. A vacuum applied to the region above the plate draws the membrane against the underside of the plate and into the holes to form suction cups which draw the wafer against the membrane. The plate is drawn up against an overlying ceramic plate which has a flat underside and a central aperture through which the vacuum is applied.

With these and other prior art chucks, wafer slippages, drops or breakages are common, particularly when loading and unloading a wafer at a loading station, or during wafer chuck and de-chuck at a polishing pad, and are costly, particularly when lost wafers have already undergone expensive fabrication processing.

### SUMMARY OF INVENTION

The object of at least one aspect of the present invention is to provide a perforated plate, or a chuck incorporating such a plate, for use in a wafer-handling operation. The object of at least one aspect the present invention is to carry a wafer in a wafer-handling chuck with an improved reliability.

In broad terms a first aspect of the invention may be said to be a perforated plate having a pair of opposite substantially planar faces and a plurality of through holes extending between the faces, wherein a first one of the faces has a plurality of grooves each of which interconnect a respective pair of the through holes.

Preferably, two of the through holes are located at different radial distances from a central zone of the plate and are interconnected by at least one of the grooves.

Preferably, at least one of the grooves extends through a substantially central zone on the first face of the plate.

Preferably, one or more of the grooves extends diametrically across the central zone to interconnect a respective pair of the through holes, two or more of the through holes lie on a common radius extending from the central zone with the or each pair of adjacent through holes lying on the common radius being interconnected by a respective groove.

Preferably, respective pluralities of the through holes are arranged to lie on substantially concentric circles.

Preferably, at least one of the through holes does not lie on a radius in common with other through holes but is interconnected by a respective pair of the grooves to the two closest radially inward through holes.

Preferably, respective pluralities of the through holes are arranged to lie on substantially concentric circles.

Preferably, the faces of the plate are substantially parallel.

Preferably, the plate is substantially circular.

Preferably, the faces of the plate are substantially parallel and the plate is substantially circular.

Preferably, the grooves are pressure-equalising passages interconnecting respective pairs of the through holes and the grooves allow flow of fluid to substantially equalise fluid pressure in the through holes.

In broad terms a first aspect of the invention may be said to be an apparatus for acquiring, holding and releasing an article having a planar surface, the apparatus including at least a carrier assembly having a chamber, a resilient membrane which closes one side of the chamber, and the perforated plate of the first aspect, wherein the perforated plate is located in the chamber with the second face facing the inner face of the membrane, the plate is arranged for limited movement substantially perpendicular to the second face of the plate between a first configuration, in which the second face of the plate is substantially in contact with the inner face of the membrane, and a second configuration, in which the first face of the plate is substantially in contact with a planar inner wall of the chamber, said inner chamber wall has an orifice by which a fluid pressure lower than that external to the chamber may be selectively applied to the chamber, and the orifice in the inner chamber wall is in at least indirect fluid pressure communication with the grooves and through holes in the perforated plate when the plate is in the second configuration.

Preferably, when the plate is in the second configuration, the orifice is aligned with a central zone of the perforated plate.

Preferably, when the plate is in the second configuration, the orifice communicates with the grooves and through holes in the plate via one or more grooves in said inner chamber wall.

Preferably, the one or more grooves in said inner chamber wall extend radially outwardly from the orifice.

Preferably, the inner chamber wall is one face of a ceramic disc.

Preferably, the article is semiconductor wafer.

Preferably, the apparatus is for holding the semiconductor wafer during a surface polishing or planarization process.

The invention may further be said to consist in any alternative combination of parts or features mentioned herein or shown in the accompanying drawings. Known equivalents of these parts or features which are not expressly set out are nevertheless deemed to be included.

### BRIEF DESCRIPTION OF DRAWINGS

It will be appreciated that a wafer-handling chuck may be implemented in various forms. Preferred embodiments of the invention will now be described, by way of example only and without intending to be limiting, with reference to the accompanying drawings of which:

FIG. 1 shows a plan view of a perforated plate according to one aspect of the current invention,

FIG. 2 shows a plan view of a perforated plate of a prior art wafer chuck,

FIG. 3 shows a cross-sectional side view of a wafer chuck according a second aspect of the current invention,

FIG. 4 shows a cross-sectional side view of the wafer chuck of FIG. 3, about to acquire a wafer,

FIG. 5 shows a cross-sectional side view of the wafer chuck of FIGS. 3 and 4, during a first wafer acquisition stage,

FIG. 6 shows a cross-sectional side view of the wafer chuck of FIGS. 3 to 5, during a second wafer acquisition stage, and

FIG. 7 shows a cross-sectional side view of the wafer chuck of FIGS. 3 to 6, during release of a wafer.

### DETAILED DESCRIPTION OF THE PREFERRED EMBODIMENT

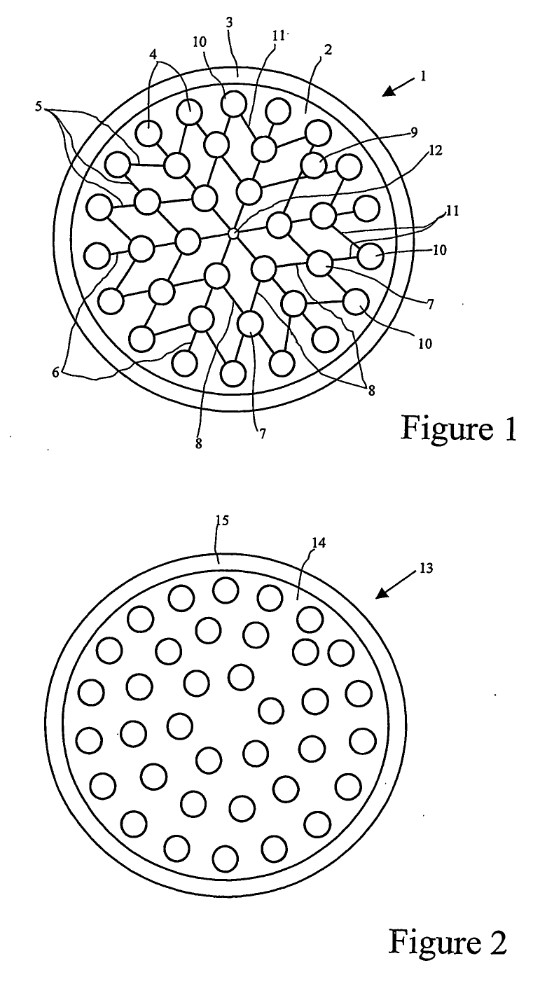

FIG. 1 shows a plan view of a circular perforated plate 1 according to the current invention. A first face 2 of the plate, i.e. the face shown in FIG. 1, has a thickened peripheral edge rim 3, but is otherwise is planar. The second, opposite face, i.e. the face not seen in FIG. 1, is planar. The rim contributes to the rigidity of the plate and assists in maintaining the planarity of the opposite faces of the plate. The opposite faces of the plate are parallel. The plate has a pattern of holes 4 which extend through the plate between the opposite faces.

In the preferred embodiment shown in FIG. 1, the through holes are interconnected by a pattern of grooves 5 in the first face. Each groove interconnects a respective pair of holes. Although other groove configurations may be used, it is preferred that the grooves be straight, as shown in FIG. 1, to provide the shortest possible groove length between the respective pairs of through holes.

The through holes are conveniently located on a series of concentric circles. In the example shown in FIG. 1, there are thirty six holes on three concentric circles. There are six holes on the innermost circle, twelve holes on the intermediate circle, and eighteen holes on the outermost circle.

Three of the holes are located on each of six radii which are evenly angularly spaced at 60 degrees apart.

Three grooves 6, which are respectively aligned with pairs of the six radii, extend diametrically across centre of the plate to interconnect respective pairs of the six holes lying oppositely on the innermost circle.

Alternate holes 7 on the intermediate circle lie midway between respective adjacent pairs of the six radii. Each of these alternate holes 7 is interconnected by a respective pair of grooves 8 to the two closest through holes on the innermost circle.

One of the holes 9 on the intermediate circle and lying midway between a pair of the radii is radially offset outwardly from the location otherwise dictated by this pattern. This offset is to accommodate the passage of a wafer sensor plunger (not shown in FIG. 1) through the plate as will be described further below.

Pairs of holes 10 lie on the outermost circle, evenly spaced between respective adjacent pairs of the six radii. Each of these holes 10 is interconnected by a respective pair of grooves 11 to the two closest through holes on the intermediate circle.

A blind hole 12 may be provided at the centre of the first face of the perforated plate, at the intersection of the three diametrical grooves 6.

The perforated plate may be made of metal and the grooves may be milled or formed by any other suitable method.

Other arrangements of holes and grooves are possible. In a preferable general arrangement, respective grooves radiate from a common centre to radially-innermost through holes, radial grooves interconnect radially-aligned through holes, and a pair of grooves interconnect each radially-outward through hole that is not radially aligned with another through hole to the next closest pair of radially-inward through holes.

FIG. 2 shows a plan view of a circular perforated plate 13 of the prior art. A first face 14 of the plate, i.e. the face shown in FIG. 1, has a thickened peripheral edge rim 15, but otherwise is planar. The second, opposite face, i.e. the face not seen in FIG. 1, is planar. The prior art plate has no central blind hole and no grooves in the first face, but is otherwise identical to the perforated plate 1 described above with respect to FIG. 1.

The grooves provided in the perforated plate 1 of FIG. 1 provide passages by which a vacuum applied at the centre of the first face 2 of the plate can communicate with every through hole 4, even when the first face of the plate lies in close face-to-face contact with another planar surface. This may be better appreciated from the following explanation of a preferred application of the perforated plate.

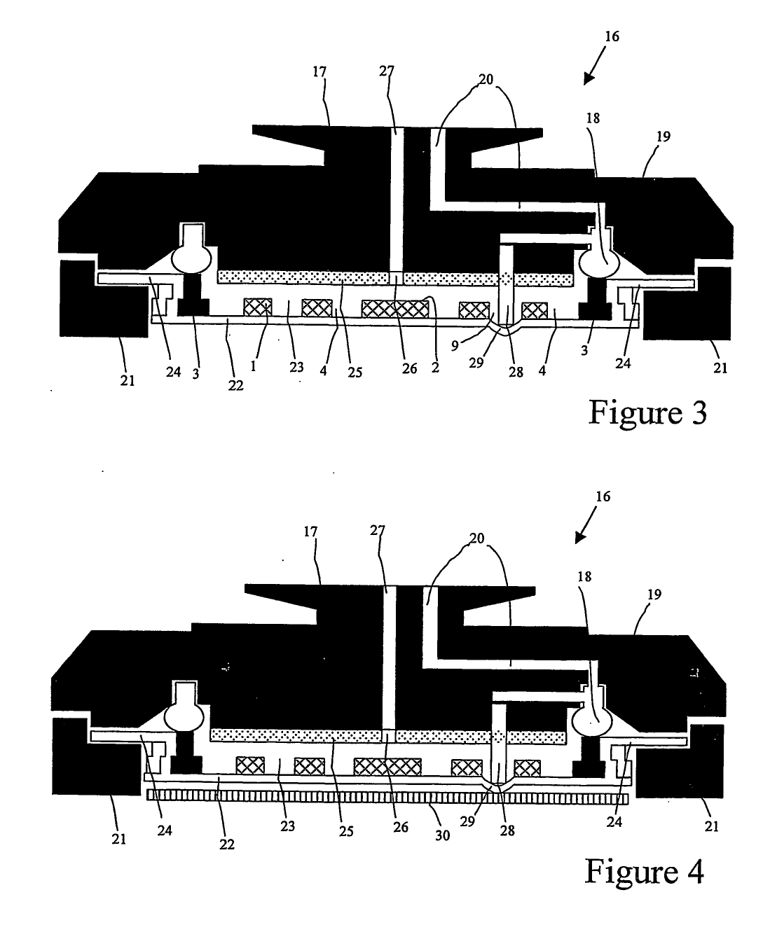

In the following description, various features are referred to by orientation; for example, by terms such as “underside”, “upper face”, upper surface”, upward facing surface”, and “downwardly”. These and similar references are given to aid in the understanding of the invention when in the orientation shown in the side views of FIGS. 3 to 7. Although the invention may be conveniently used in this orientation, the invention is not limited to the particular orientation as discussed and shown in the figures.

FIG. 3 shows a schematic cross-sectional side view of a wafer chuck 16. The wafer chuck includes a circular gimballed plate 17. An inflatable inner tube 18 is fitted in a circular groove 19 on the underside of the gimballed plate. A passage 20 leading from the upper face of the gimballed plate to the inflatable tube connects the tube to a supply of fluid pressure (not shown).

A circular rigid retaining ring 21 is fitted to the periphery of the underside of the gimballed plate 17. A resilient membrane 22 closes the underside of a chamber 23 defined by the inner circumference of the retaining ring and the underside of the gimballed plate.

A circular plate 1 perforated with through holes 4 is mounted in the chamber 23, inside the inner circumference of the retaining’ ring 21. The upper surface of the perforated plate 1 has a thickened edge rim 3 around the full periphery of the perforated plate. The rim of the perforated plate is fixed to a flexible ring 24 which is clamped between the underside of the gimballed plate and an upward facing surface of the retaining ring. The flexible ring 24 restrains the perforated plate 1 against radial movement while permitting axial movement of the perforated plate between a first, lowered configuration, in which the lower face of the perforated plate contacts the upper face of the membrane 22, and a second, raised configuration, in which the upper face of the perforated plate contacts the underside of a ceramic disc 25 fitted to the underside of the gimballed plate. The ceramic disc has a central aperture 26 which is aligned with a pressure/vacuum supply passage 27 which extends through the central axis of the gimballed plate.

The inflatable tube 18 bears against the rim 3 of the perforated plate 1. Inflation and deflation of the tube can be used to control the raising and lowering of the perforated plate.

A sensor plunger 28, for sensing the presence of a wafer on the chuck 16, is fitted to the gimballed plate 17 at a location radially offset from the central axis of the gimballed plate.

The sensor plunger 28 is arranged to slide vertically so that its lower end can protrude through one of the apertures in the perforated plate 1. The plunger is biased downwardly by a spring (not shown) to press against the upper face of the membrane 22 and cause a local downward distortion 29 in the membrane in the vicinity of that one aperture.

The protrusion of the sensor plunger and the local distortion of the membrane occurs if a wafer is not located flat against the underside of the membrane. If a wafer is located flat against the underside of the membrane, it pushes the local distortion of the membrane and the sensor plunger upward to provide an indication of the presence of the wafer.

FIG. 4 shows a cross-sectional side view of the wafer chuck 16 positioned over a wafer 30 at a wafer loading station (not shown). The sensor plunger 28 is down, causing a local distortion 29 in the membrane 22.

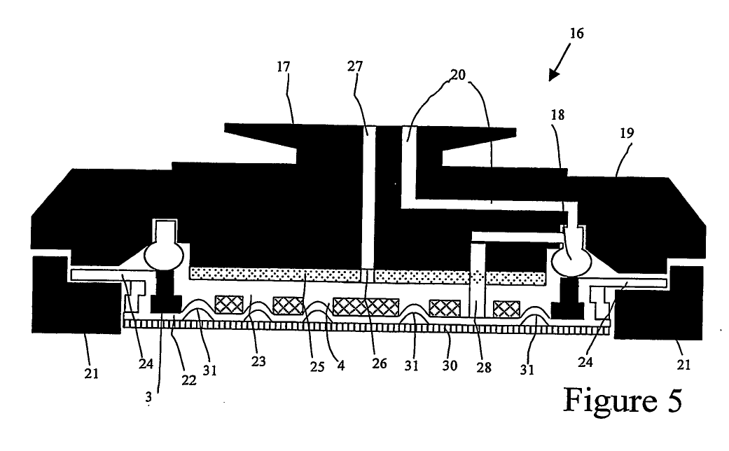

In a first wafer acquisition stage, fluid (e.g. air) pressure is applied, via the passage 20 through the gimballed plate 17, to the circular inflatable tube 18. The tube inflates and drives the perforated plate 1 downward to press the membrane 22 flat against the upper face of the wafer 30, as shown in FIG. 5.

FIG. 5 also shows the chuck 16 with a vacuum applied to the chamber 23 via the axial supply passage 27 through the gimballed plate 17. The applied vacuum draws portions of the membrane 22 up into the through holes 4 in the perforated plate 1 to form localised suctions cups 31 which draw the wafer 30 into close contact with the generally flat remainder of the membrane 22. This draws the membrane into close contact with the perforated plate.

The wafer 30 presses the local downward distortion 29 of the membrane 22 and the sensor plunger 28 upward to indicate a successful initial acquisition of the wafer by the chuck 16. In response to this indication, the fluid pressure applied to the circular inflatable tube 18 is removed and the tube allowed to deflate. This deflation is helped by the continued application of the vacuum applied to the chamber 23. The relatively higher ambient air pressure outside the chamber pushes the wafer 30 upward against the membrane 22, and the membrane against the perforated plate 1.

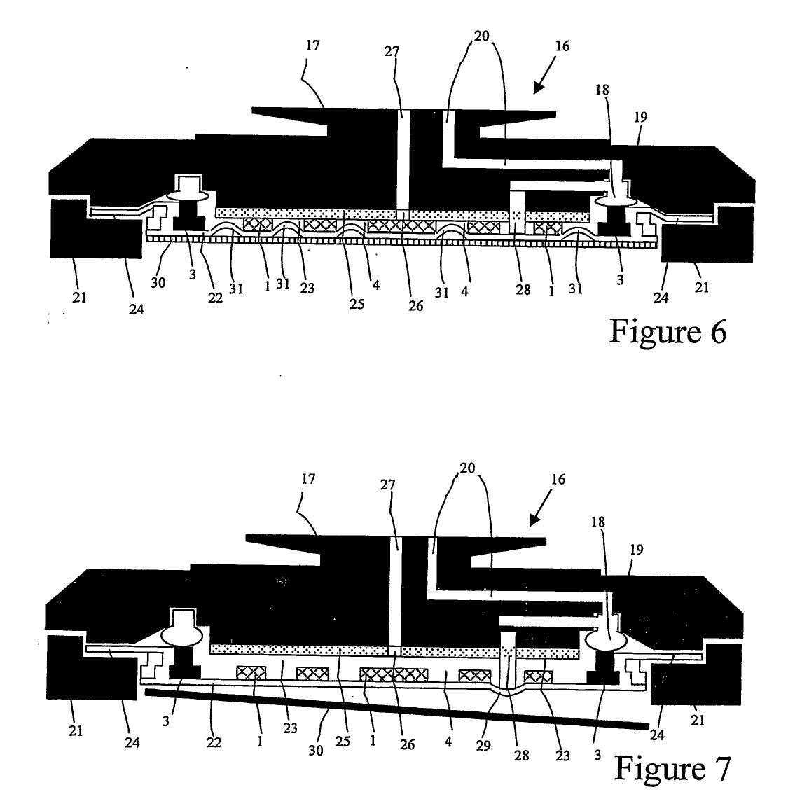

The wafer 30, membrane 22 and perforated plate 1 together move upward, as shown in FIG. 6, to compress and deflate the tube 18. The upper face of the perforated plate 1 moves into close face-to-face contact with the underside of the ceramic disc 25. The underside of the ceramic disc 25 has a number of radial grooves (not shown) which connect with and radiate outwardly from the central passage 26 in the ceramic disc. These grooves in the ceramic disc help distribute the applied vacuum/pressure outwardly across the upper face of the perforated plate to the through holes 4 in the perforated plate.

The radial distribution grooves in the ceramic disc 25 do not necessarily align with every through hole 4 in the perforated plate 1. However, the grooves 5 in the upper face of the perforated plate 1 ensure the reliable application of the full vacuum to every through hole 4 in the perforated plate, thereby improving the reliability of the attachment of the wafer 30 to the chuck 16 by the action of the membrane suction cups 31.

The continued presence of the sensor plunger 28 in its raised position indicates that the wafer 3 0 continues to be correctly held by the chuck.

Wafer chucks of the prior art are similar to that described above in respect of FIGS. 3 to 6 but use a perforated plate 13 as shown in FIG. 2, i.e. without grooves in the upper face to interconnect the through holes. In these prior art chucks the lack of alignment of the radial grooves in the underside of the ceramic disc with the through holes in the perforated disc impedes the reliable application of the vacuum to at least some of the through holes in the perforated plate. This impediment occurs particularly when the perforated plate is in close face-to-face contact with the underside of the ceramic disc and reduces the effectiveness of at least some of the suction cups in securing the wafer to the chuck. This can result in slippage of a wafer from the chuck and wafer breakage. Such slippages and breakages are costly, particularly when the lost wafers have already undergone expensive fabrication processing.

FIG. 7 shows a cross-sectional side view of the wafer chuck 16 of FIGS. 3 to 6, during release of a wafer 30 from the chuck. The chuck is moved to locate the wafer over an unloading station (not shown). The vacuum applied to the chamber 23 is vented to atmosphere allowing the perforated plate 1, with the membrane 22 and wafer 30 in close association, to drop. The membrane returns, under its inherent resilience, to a generally planar form without the suction cups 31 that were previously formed at the through holes 4 in the perforated plate 1. In the absence of the suction cups, the wafer 30 is released from the underside of the membrane 22 to rest on the unloading station.

When the wafer 30 is released from the chuck 16, the spring-biased sensor plunger 28 is no longer restrained in its raised position and it moves downward causing a local distortion 29 in the membrane 22, as shown in FIG. 7. Upon moving to this downward position the sensor plunger 28 provides an indication of a successful release of the wafer 30.

The foregoing describes the invention including preferred forms thereof. Alterations and modifications as will be obvious to those skilled in the art are intended to be incorporated within the scope of the invention as defined in the accompanying claims.

It is to be understood that the numerical references included in parentheses in the following claims are given merely as a guide in understanding the correspondence between integers of the claims and the features of the exemplary but non-limiting embodiments shown in the figures. The claims are not intended to be limited to the features or arrangements as shown in the figures.

### LIST OF FEATURES LABELLED IN THE DRAWINGS

1. perforated plate

2. first (upper) face of the perforated plate

3. peripheral edge rim

4. through hole

5. groove

6. diametrical groove

7. alternate holes on intermediate circle

8. groove from alternate hole

9. hole for sensor plunger

10. hole on outermost circle

11. groove connecting outermost hole

12. blind hole

13. perforated plate (prior art)

14. first (upper) face of the prior art plate

15. edge rim of prior art plate

16. wafer chuck

17. gimballed plate

18. inflatable tube

19. circular groove

20. passage to inflatable tube

21. retaining ring

22. membrane

23. chamber

24. flexible ring

25. ceramic disc

26. central aperture in ceramic disc

27. pressure/vacuum supply passage

28. sensor plunger

29. local distortion of membrane

30. wafer

31. suction cup

1. A perforated plate having a pair of opposite substantially planar faces and a plurality of through holes extending between the faces, wherein a first one of the faces has a plurality of grooves each of which interconnect a respective pair of the through holes.

2. The perforated plate as claimed in claim 1, wherein two of the through holes are located at different radial distances from a central zone of the plate and are interconnected by at least one of the grooves.

3. The perforated plate as claimed in claim 1, wherein at least one of the grooves extends through a substantially central zone on the first face of the plate.

4. The perforated plate as claimed in claim 1, wherein one or more of the grooves extends diametrically across the central zone to interconnect a respective pair of the through holes, two or more of the through holes lie on a common radius extending from the central zone with each pair of adjacent through holes lying on the common radius being interconnected by a respective groove.

5. The perforated plate as claimed in claim 4, wherein respective pluralities of the through holes are arranged to lie on substantially concentric circles.

6. The perforated plate as claimed in claim 4, wherein at least one of the through holes does not lie on a radius in common with other through holes but is interconnected by a respective pair of the grooves to the two closest radially-inward through holes.

7. The perforated plate as claimed in claim 6, wherein respective pluralities of the through holes are arranged to lie on substantially concentric circles.

8. The perforated plate as claimed in claim 1, wherein the faces of the plate are substantially parallel.

9. The perforated plate as claimed in claim 1, wherein the plate is substantially circular.

10. The perforated plate as claimed in claim 1, wherein the faces of the plate are substantially parallel and the plate is substantially circular.

11. The perforated plate as claimed in claim 1, wherein the grooves are pressure-equalizing passages interconnecting respective pairs of the through holes and the grooves allow flow of fluid to substantially equalize fluid pressure in the through holes.

12. An apparatus for acquiring, holding and releasing an article having a planar surface, the apparatus including at least a carrier assembly having a chamber, a resilient membrane which closes one side of the chamber, and the perforated plate as claimed in claim 1, wherein the perforated plate is located in the chamber with the second face facing the inner face of the membrane, the plate is arranged for limited movement substantially perpendicular to the second face of the plate between a first configuration, in which the second face of the plate is substantially in contact with the inner face of the membrane, and a second configuration, in which the first face of the plate is substantially in contact with a planar inner wall of the chamber, said inner chamber wall has an orifice by which a fluid pressure lower than that external to the chamber may be selectively applied to the chamber, and the orifice in the inner chamber wall is in at least indirect fluid pressure communication with the grooves and through holes in the perforated plate when the plate is in the second configuration.

13. The apparatus as claimed in claim 12, wherein, when the plate is in the second configuration, the orifice is aligned with a central zone of the perforated plate.

14. The apparatus as claimed in claim 13, wherein, when the plate is in the second configuration, the orifice communicates with the grooves and through holes in the plate via one or more grooves in said inner chamber wall.

15. The apparatus as claimed in claim 14, wherein the one or more grooves in said inner chamber wall extend radially outwardly from the orifice.

16. The apparatus as claimed in claim 12, wherein said inner chamber wall is one face of a ceramic disc.

17. The apparatus as claimed in claim 12, wherein the article is a semiconductor wafer.

18. The apparatus as claimed in claim 17, wherein the apparatus is for holding the semiconductor wafer during a surface polishing or planarization process.
